(19) United States
(12) Patent Application Publication
(10) Pub. No.: US 2026/0257319 A1
(43) Pub. Date: Sep. 3, 2026

(54) WRENCH

(71) Applicant: HANGZHOU GREAT STAR INDUSTRIAL CO., LTD., Hangzhou (CN)

(72) Inventor: Wei WANG, Hangzhou (CN)

(21) Appl. No.: 19/654,505

(22) Filed: Apr. 22, 2026

Related U.S. Application Data
(63) Continuation of application No. PCT/CN2023/125842, filed on Oct. 23, 2023.

(51) Int. Cl. B25B 13/46

(52) U.S. Cl. CPC B25B 13/463

(57) ABSTRACT

A wrench is provided. The wrench includes a wrench body, a driving member, a tooth portion, a first pawl assembly, and elastic members. The driving member is rotatably disposed on the wrench body. The tooth portion is coaxially disposed on a side surface of the driving member and rotatable synchronously with the driving member. The first pawl assembly is movably disposed on the wrench body. The first pawl assembly includes a first pawl and a second pawl arranged along a circumferential direction of the tooth portion so as to limit the tooth portion to rotate relative to the wrench body in a preset direction. When at least a portion of the first pawl is engaged with the tooth portion, at least a portion of the second pawl is in a state of incomplete engagement with the tooth portion.

### CROSS-REFERENCE TO RELATED APPLICATION

This application is a continuation of international patent application No. PCT/CN 2023/125842, filed on Oct. 23, 2023, and titled “WRENCH”. The content of the above identified application is hereby incorporated herein in its entirety by reference.

### TECHNICAL FIELD

The present disclosure relates to the technical field of operation tools, and in particular, to a wrench.

### BACKGROUND

A wrench is a tool used for tightening or loosening components such as sockets, nuts, and bolts. In an existing ratchet wrench, after a main shaft is engaged with components such as the sockets, the nuts, and the bolts, a rotating force is applied via a handle. At this time, the main shaft can rotate synchronously with the handle to achieve a purpose of tightening or loosening the components such as the sockets, the nuts, and the bolts. When the operating space is relatively small, it is necessary to rotate the handle backward by a certain angle. At this time, the main shaft is fixed relative to the components such as the sockets, the nuts, and the bolts. When the handle is rotated back to an initial position, force is applied again by rotation to tighten or loosen the components such as the sockets, the nuts, and the bolts.

When the handle is rotated backward, it is necessary to rotate a ratchet by at least an angle corresponding to one tooth gap. However, when the operating space is so narrow that rotation by an angle corresponding to one tooth gap is impossible, the ratchet wrench cannot be used, resulting in a limited application of the ratchet wrench.

In related conventional techniques, some ratchet wrenches increase the number of teeth by reducing a tooth profile, thereby achieving an effect of multiple times of teeth. However, a smaller tooth profile may result in insufficient torque or tooth breakage, leading to poor strength of the wrench.

### SUMMARY

According to various embodiments of the present disclosure, a wrench is provided.

The present disclosure provides a wrench. The wrench includes a wrench body, a driving member, a tooth portion, a first pawl assembly, and elastic members. The driving member is rotatably disposed on the wrench body and configured to drive an external element. The tooth portion is coaxially disposed on a side surface of the driving member and rotatable synchronously with the driving member. The first pawl assembly is movably disposed on the wrench body, and the first pawl assembly includes a first pawl and a second pawl arranged along a circumferential direction of the tooth portion. Each of the first pawl and the second pawl is configured to be engaged with the tooth portion, such that the driving member rotates synchronously with the wrench body in a preset direction. When at least a portion of the first pawl is engaged with the tooth portion, at least a portion of the second pawl is in a state of incomplete engagement with the tooth portion. The elastic members are configured to apply an elastic force to the first pawl and the second pawl, such that at least a portion of the first pawl and at least a portion of the second pawl both have a tendency to move toward a side proximal to the tooth portion.

Details of one or more embodiments of the present disclosure are presented in the attached drawings and descriptions below. Other features, purposes, and advantages of the present disclosure will become apparent from the description, drawings, and claims.

### BRIEF DESCRIPTION OF THE DRAWINGS

For a better description and illustration of embodiments and/or examples of the inventions disclosed herein, reference may be made to one or more accompanying drawings. Additional details or examples used to describe the drawings should not be considered as limiting the scope of any of the disclosed inventions, the presently described embodiments and/or examples, and the best mode of these inventions as presently understood.

FIG. 1 is a schematic perspective view of a wrench according to an embodiment of the present disclosure.

FIG. 2 is a schematic structural view of the wrench shown in FIG. 1 from a rear perspective according to the present disclosure.

FIG. 3 is a first partial structural schematic view of a wrench according to an embodiment of the present disclosure.

FIG. 4 is a second partial structural schematic view of a wrench according to an embodiment of the present disclosure.

FIG. 5 is a third partial structural schematic view of a wrench according to an embodiment of the present disclosure.

FIG. 6 is a fourth partial structural schematic view of a wrench according to an embodiment of the present disclosure.

FIG. 7 is a partial perspective structural schematic view of a wrench according to an embodiment of the present disclosure.

FIG. 8 is a cross-sectional structural schematic view of the wrench shown in FIG. 7 according to the present disclosure.

FIG. 9 is a partial structural schematic view of a wrench according to an embodiment of the present disclosure.

FIG. 10 is a partial perspective structural schematic view of a wrench according to an embodiment of the present disclosure.

FIG. 11 is a cross-sectional structural schematic view of the wrench shown in FIG. 10 according to the present disclosure.

FIG. 12 is a partial structural schematic view of a wrench according to an embodiment of the present disclosure.

FIG. 13 is a first partial structural schematic view of a wrench according to an embodiment of the present disclosure.

FIG. 14 is a second partial structural schematic view of a wrench according to an embodiment of the present disclosure.

FIG. 15 is a cross-sectional structural schematic view of the wrench shown in FIG. 13 according to the present disclosure.

FIG. 16 is a partial perspective structural schematic view of a wrench according to an embodiment of the present disclosure.

FIG. 17 is a cross-sectional structural schematic view of a wrench according to an embodiment of the present disclosure.

FIG. 18 is a cross-sectional structural schematic view of the wrench shown in FIG. 2 according to the present disclosure.

FIG. 19 is a structural schematic view of a wrench according to an embodiment of the present disclosure.

FIG. 20 is an exploded structural schematic view of the wrench shown in FIG. 19.

FIG. 21 is a structural schematic view of the wrench shown in FIG. 19 from another perspective.

FIG. 22 is a partial cross-sectional structural schematic view of the wrench shown in FIG. 21 taken along a section line A-A.

FIG. 23 is a partial cross-sectional structural schematic view of the wrench shown in FIG. 21 taken along a section line B-B.

FIG. 24 is a first partial structural schematic view of the wrench shown in FIG. 19.

FIG. 25 is a second partial structural schematic view of the wrench shown in FIG. 19.

FIG. 26 is a structural schematic view of the wrench shown in FIG. 19 in another state.

FIG. 27 is a partial cross-sectional structural schematic view of the wrench shown in FIG. 26.

In the drawings, 100 represents a wrench; 1 represents a wrench body; 11 represents a recess; 12 represents a limiting groove; 13 represents a handle; 14 represents an operating portion; 141 represents a closure plate; 2 represents a driving member; 3 represents a tooth portion; 4 represents a first pawl assembly; 41 represents a first pawl; 42 represents a second pawl; 43 represents a fifth pawl; 5 represents a second pawl assembly; 51 represents a third pawl; 52 represents a fourth pawl; 53 represents a sixth pawl; 40 represents a first tooth block; 50 represents a second tooth block; 405 represents a ratchet tooth; 101 represents a first mounting groove; 1011 represents a first groove portion; 1012 represents a second groove portion; 102 represents a second mounting groove; 1021 represents a third groove portion; 1022 represents a fourth groove portion; 601 represents a limiting space; 602 represents an engaging space; 6 represents a reversing assembly; 61 represents a reversing member; 611 represents a protruding portion; 612 represents a recessed portion; 62 represents a driving portion; 621 represents a convex portion; 622 represents a concave portion; 63 represents a first rotating member; 64 represents a second rotating member; 65 represents a first transmission member; 66 represents a second transmission member; 67 represents an arc-shaped groove; 68 represents an arc-shaped block; 69 represents a toggle member; 7 represents an elastic member; 71 represents a first elastic member; 72 represents a second elastic member; and 200 represents an external element.

### DETAILED DESCRIPTION

In order to make the above objects, features, and advantages of the present disclosure more obvious and understandable, specific embodiments of the present disclosure will be described in detail below with reference to the accompanying drawings. In the following description, many specific details are set forth in order to fully understand the present disclosure. However, the present disclosure can be implemented in many other ways different from those described herein, and those skilled in the art can make similar improvements without violating the connotation of the present disclosure. Therefore, the present disclosure is not limited by the specific embodiments disclosed below.

It should be noted that when a component is referred to as being “fixed to” or “provided on” another component, the component may be directly on the other component or an intermediate component may also exist. When a component is considered as being “connected to” another component, the component may be directly connected to the other component or an intermediate component may also exist at the same time. Terms such as “vertical”, “horizontal”, “upper”, “lower”, “left”, “right” and other similar expressions used in the description of the present disclosure are only for the purpose of illustration and do not represent the unique implementation.

In addition, terms such as “first” and “second” are merely used for descriptive purposes, and cannot be understood as indicating or implying relative importance or implicitly indicating the quantity of the technical features referred to. Thus, features defined with “first” and “second” may explicitly or implicitly include at least one of the features. In the description of the present disclosure, “a plurality of” means at least two, for example, two, three, and the like, unless specifically defined otherwise.

In the present disclosure, unless otherwise explicitly specified and defined, a first feature being “on” or “under” a second feature may refer to the first feature and the second feature being in direct contact, or in indirect contact through an intermediary. Also, when the first feature is described as “on”, “above”, and “over” the second feature, this may mean the first feature is directly above or obliquely above the second feature, or merely indicate that the first feature is horizontally higher than the second feature. When the first feature is described as “under”, “below”, and “beneath” the second feature, this may mean the first feature is directly below or obliquely below the second feature, or merely indicate that the first feature is horizontally lower than the second feature.

Unless otherwise defined, all technical and scientific terms used in the description of the present disclosure have the same meaning as commonly understood by those skilled in the art to which the present disclosure belongs. The terms used in the description of the present disclosure are for the purpose of describing specific embodiments only, and are not intended to limit the present disclosure. As used herein, the term “and/or” means any and all combinations of one or more of the associated listed items.

In an existing ratchet wrench, after a main shaft is engaged with components such as sleeves, nuts, and bolts, a rotating force is applied via a handle. At this time, the main shaft can rotate synchronously with the handle to achieve a purpose of tightening or loosening the components such as the sockets, nuts, and bolts. When the operating space is relatively small, it is necessary to rotate the handle backward by a certain angle. At this time, the main shaft is fixed relative to the components such as the sockets, nuts, and bolts. When the handle is rotated back to an initial position, force is applied again by rotation to tighten or loosen the components such as the sockets, nuts, and bolts. When the handle is rotated backward, it is necessary to rotate the ratchet by at least an angle corresponding to one tooth gap. However, when the operating space is so narrow that rotation by an angle corresponding to one tooth gap is impossible, the ratchet wrench cannot be used, resulting in a limited application range of the ratchet wrench.

In related conventional techniques, some ratchet wrenches increase the number of teeth by reducing a tooth profile, thereby achieving an effect of multiple times of teeth. However, a smaller tooth profile may result in insufficient torque or tooth breakage, leading to poor strength of the wrench. Some other ratchet wrenches are provided with two pawls arranged in parallel along an axial direction of the ratchet, with a lateral angular offset between the two pawls. Although the effect of multiple times of teeth can be achieved by such configuration, a width of each pawl can only be half of that of the ratchet, which results in a small contact area between each pawl and the ratchet, thereby reducing a transmission strength between the pawls and the ratchet. Consequently, the strength of such a wrench is still poor and prone to be damaged.

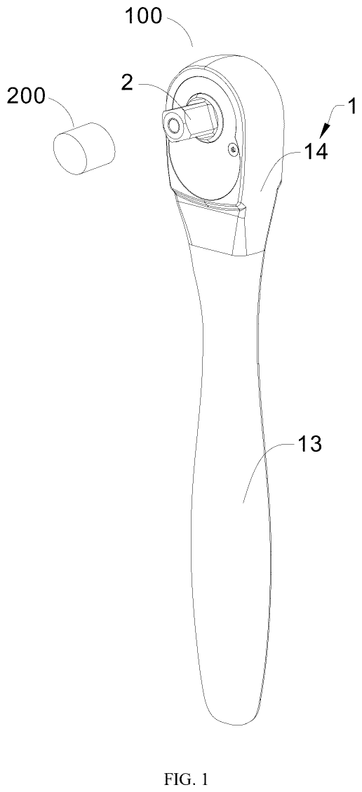

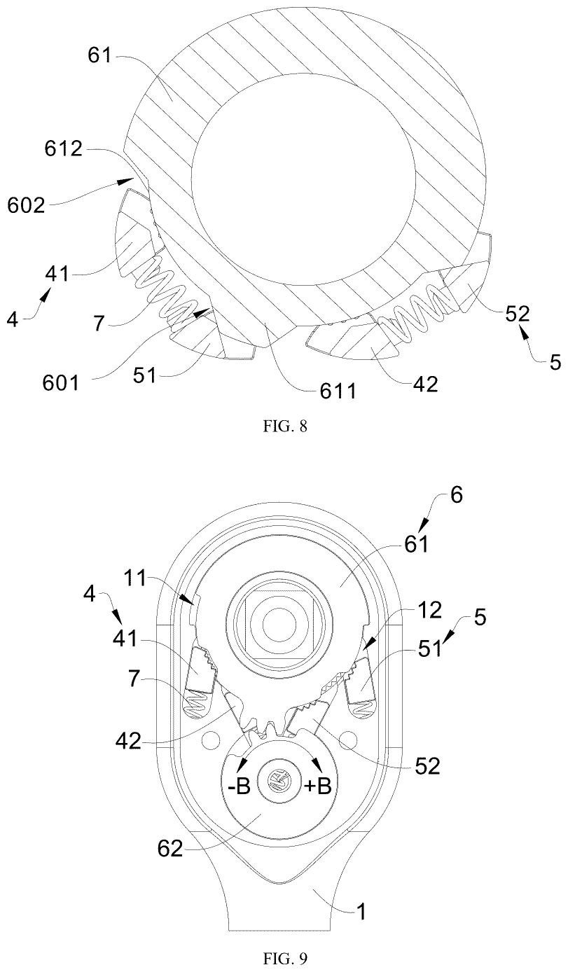

To resolve the above problems, as shown in FIG. 1 to FIG. 16, the present disclosure provides a wrench 100, which can be used in a narrow operating space while ensuring strength.

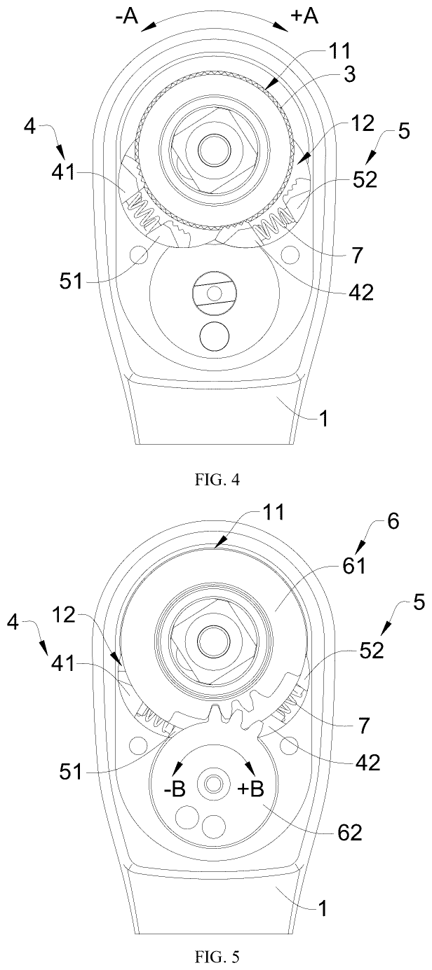

As shown in FIG. 1 and FIG. 4, the wrench 100 includes a wrench body 1, a driving member 2, a tooth portion 3, a first pawl assembly 4, and elastic member 7. The driving member 2 is rotatably disposed on the wrench body 1 and configured to drive an external element 200. The tooth portion 3 is coaxially disposed on a side surface of the driving member 2 and rotatable synchronously with the driving member 2. The first pawl assembly 4 is movably disposed on the wrench body 1. The first pawl assembly 4 includes a first pawl 41 and a second pawl 42 arranged along a circumferential direction of the tooth portion 3. Each of the first pawl 41 and the second pawl 42 is configured to be engaged with the tooth portion 3, such that the driving member 2 rotates synchronously with the wrench body 1 in a preset direction (i.e., rotate in a −A direction as shown in IFG. 4, taking an axis of the driving member 2 as a rotation center). When the first pawl 41 is engaged with the tooth portion 3, the second pawl 42 is in a state of incomplete engagement with the tooth portion 3. The elastic members 7 are configured to apply an elastic force to the first pawl 41 and the second pawl 42, such that the first pawl 41 and the second pawl 42 have a tendency to move toward a side proximal to the tooth portion 3.

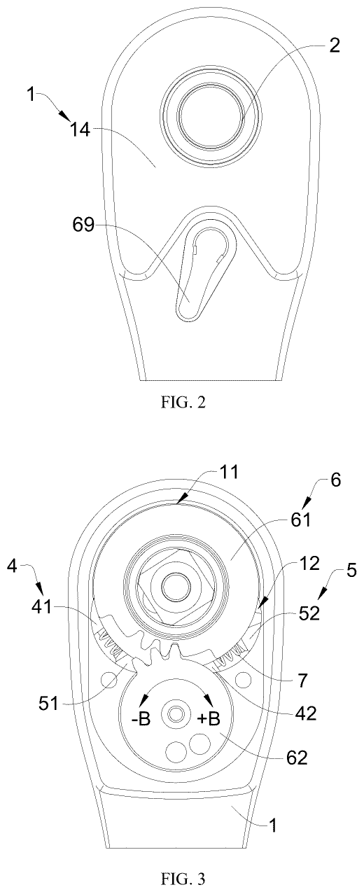

As shown in FIG. 1 to FIG. 2, the wrench body 1 may include a handle 13 and an operating portion 14 disposed at one end of the handle 13, and the driving member 2 may be disposed on the operating portion 14.

The driving member 2 may cooperate with components such as sockets, nuts, and bolts. When the handle 13 is controlled to rotate in the −A direction shown in FIG. 4 by taking the axis of the driving member 2 as the rotation center, since the first pawl 41 and the second pawl 42 when engaged with the tooth portion 3 may cause the driving member 2 to rotate synchronously with the wrench body 1 in the −A direction, the driving member 2 can tighten or loosen the components such as the sockets, nuts, and bolts. When the handle 13 is controlled to rotate in an +A direction shown in FIG. 4 by taking the axis of the driving member 2 as the rotation center, the tooth portion 3 may slip relative to the first pawl 41 and the second pawl 42. Therefore, the wrench body 1 can rotate alone in the +A direction shown in FIG. 4, and the tooth portion 3 and the driving member 2 may be fixed relative to components such as the sockets, nuts, and bolts.

As described above, in existing ratchet wrenches, when the handle is rotated backward, it is necessary to rotate the ratchet by at least an angle corresponding to one tooth gap. However, when the operating space is so narrow that rotation by an angle corresponding to one tooth gap is impossible, the ratchet wrench cannot be used, thereby limiting the application range of the ratchet wrench. In the wrench 100 according to an embodiment of the present disclosure, when the first pawl 41 is engaged with the tooth portion 3, the second pawl 42 is in a state of incomplete engagement with the tooth portion 3. When the second pawl 42 is engaged with the tooth portion 3, the first pawl 41 is in a state of incomplete engagement with the tooth portion 3. Thus, when the wrench body 1 rotates in the +A direction shown in FIG. 4, the wrench body 1 may be only required to rotate by an angle smaller than one tooth gap of the tooth portion 3 before the wrench body 1 can rotate again in the −A direction shown in FIG. 4, so as to tighten or loosen components such as sockets, nuts, and bolts, thereby achieving an effect of multiple times of teeth and enabling the use of the wrench 100 in a narrow operating space. The elastic member 7 may be configured to apply a pre-tightening force toward the tooth portion 3 to the first pawl 41 and the second pawl 42, such that the first pawl 41 and the second pawl 42 may have a tendency to move toward a side proximal to the tooth portion 3, thereby assisting the engagement of the first pawl 41 and the second pawl 42 with the tooth portion 3.

Compared to conventional techniques that reduce the tooth profile to increase the number of teeth, or that two pawls are arranged in parallel along an axial direction of the ratchet with a lateral angular offset, the wrench 100 according to the present disclosure does not require changing the size of the tooth profile of the tooth portion 3. In addition, the first pawl 41 and the second pawl 42 are arranged along the circumferential direction of the tooth portion 3. Therefore, each of the first pawl 41 and the second pawl 42 can have a width equal to or slightly larger than a width of the tooth portion 3 (i.e., a dimension along the axial direction of the tooth portion 3), thereby increasing the contact areas between the first pawl 41 and the tooth portion 3 and between the second pawl 42 and the tooth portion 3, ensuring the transmission strengths between the first pawl 41 and the tooth portion 3 and between the second pawl 42 and the tooth portion 3, avoiding tooth breakage due to insufficient torques between the first pawl 41 and the tooth portion 3 and between the second pawl 42 and the tooth portion 3, thereby ensuring the strength of the wrench 100.

In the illustrated embodiment, when the first pawl 41 is engaged with the tooth portion 3, i.e., when a tooth tip of the first pawl 41 is opposite to a groove bottom of a tooth groove of the tooth portion 3, a tooth tip of the second pawl 42 may be opposite to a tooth tip of the tooth portion 3. When the second pawl 42 is engaged with the tooth portion 3, i.e., when the tooth tip of the second pawl 42 is opposite to the groove bottom of the tooth groove of the tooth portion 3, the tooth tip of the first pawl 41 may be opposite to the tooth tip of the tooth portion 3. When the wrench body 1 rotates in the +A direction shown in FIG. 4, the wrench body 1 may be only required to rotate by an angle corresponding to half the tooth gap of the tooth portion 3 before the wrench body 1 can rotate again in the −A direction shown in FIG. 4, so as to tighten or loosen components such as the sockets, nuts and bolts, thereby enabling the use of the wrench 100 in a narrow operating space. In other embodiments, when the tooth tip of the first pawl 41 is engaged with the tooth groove of the tooth portion 3, the tooth tip of the second pawl 42 may be opposite to a sidewall of the tooth groove of the tooth portion 3. When the tooth tip of the second pawl 42 is engaged with the tooth groove of the tooth portion 3, the tooth tip of the first pawl 41 may be opposite to the sidewall of the tooth groove of the tooth portion 3.

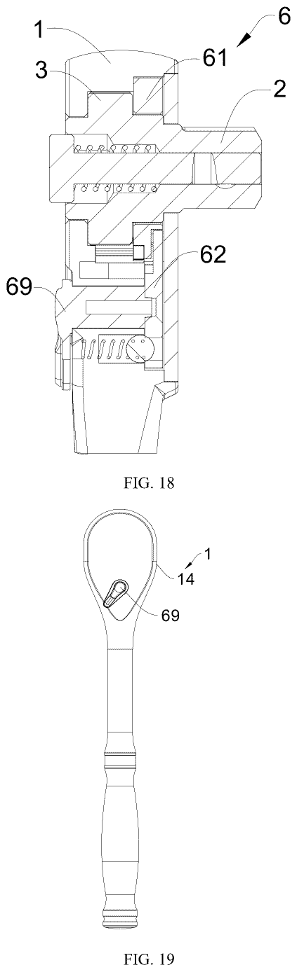

The driving member 2 may include a driving shaft or a driving ring. As shown in FIG. 18, the driving shaft may be configured as a solid shaft or a non-solid shaft. The driving shaft can be inserted into an external element 200 such as a screw, and other components can be provided inside the non-solid shaft. As shown in FIG. 17, a through hole may be provided at the center of the driving ring, such that the driving ring can be sleeved on the outside of the external element 200 such as a nut. In this way, the scope of application of the wrench 100 can be expanded. The driving member 2 may be integrally formed with the tooth portion 3, or the driving member 2 and the tooth portion 3 may be formed as separate structures and connected by fixing means such as screws, adhesive bonding, or fitting engagement.

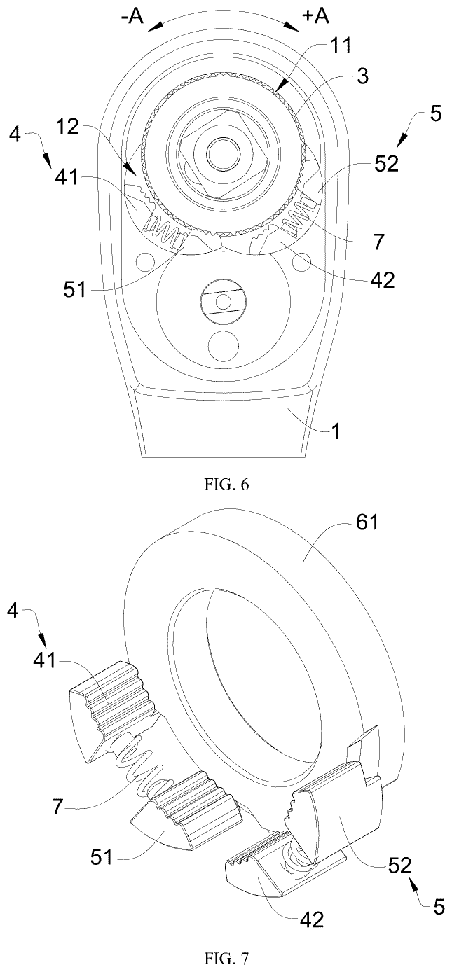

As shown in FIG. 4 and FIG. 6, the wrench 100 may further include a second pawl assembly 5. The second pawl assembly 5 may be movably disposed on the wrench body 1, and the second pawl assembly 5 may be configured to be engaged with the tooth portion 3, such that the driving member 2 and the wrench body 1 rotate synchronously in a direction opposite to the preset direction synchronously (i.e., rotating in the +A direction as shown in FIG. 6, taking the axis of the driving member 2 as the rotation center). The wrench 100 may further include a reversing assembly 6 disposed on the wrench body 1. The reversing assembly 6 may be configured to change positions of the first pawl assembly 4 and the second pawl assembly 5, such that at least one of the first pawl assembly 4 and the second pawl assembly 5 is engageable with the tooth portion 3. When the reversing assembly 6 controls the first pawl assembly 4 to be engaged with the tooth portion 3, the wrench body 1 can rotate in the −A direction shown in FIG. 4, so as to tighten or loosen components such as sockets, nuts, and bolts via the driving member 2. When the reversing assembly 6 controls the second pawl assembly 5 to be engaged with the tooth portion 3, the wrench body 1 can rotate in the +A direction shown in FIG. 6, so as to tighten or loosen components such as sockets, nuts and bolts via the driving member 2. Thus, the wrench 100 can be operated conveniently and easily.

Specifically, the second pawl assembly 5 may include a third pawl 51 and a fourth pawl 52 arranged along the circumferential direction of the tooth portion 3. Each of the third pawl 51 and the fourth pawl 52 may be configured to be engaged with the tooth portion 3. When the third pawl 51 is engaged with the tooth portion 3, the fourth pawl 52 may be in a state of incomplete engagement with the tooth portion 3. When the fourth pawl 52 is engaged with the tooth portion 3, the third pawl 51 may be in a state of incomplete engagement with the tooth portion 3. In the illustrated embodiment, when the third pawl 51 is engaged with the tooth portion 3, i.e., when the tooth tip of the third pawl 51 is opposite to the groove bottom of the tooth groove of the tooth portion 3, the tooth tip of the fourth pawl 52 may be opposite to the tooth tip of the tooth portion 3. When the fourth pawl 52 is engaged with the tooth portion 3, i.e., when the tooth tip of the fourth pawl 52 is opposite to the groove bottom of the tooth groove of the tooth portion 3, the tooth tip of the third pawl 51 may be opposite to the tooth tip of the tooth portion 3. Thus, when the wrench body 1 rotates in the −A direction shown in FIG. 6, the wrench body 1 may be only required to rotate by the angle corresponding to half the tooth gap of the tooth portion 3 before the wrench body 1 can rotate again in the +A direction shown in FIG. 6, so as to tighten or loosen components such as sockets, nuts, and bolts, thereby enabling the use of the wrench 100 in a narrow operating space. In other embodiments, when the tooth tip of the third pawl 51 is engaged with the tooth groove of the tooth portion 3, the tooth tip of the fourth pawl 52 may be opposite to the sidewall of the tooth groove of the tooth portion 3. When the tooth tip of the fourth pawl 52 is engaged with the tooth groove of the tooth portion 3, the tooth tip of the third pawl 51 may be opposite to the sidewall of the tooth groove of the tooth portion 3.

When the third pawl 51 and the fourth pawl 52 are engaged with the tooth portion 3, by controlling the handle 13 to rotate in the +A direction shown in FIG. 6, taking the axis of the driving member 2 as the rotation center, since the third pawl 51 and the fourth pawl 52 when engaged with the tooth portion 3 may cause the driving member 2 to rotate synchronously with the wrench body 1 in the +A direction, components such as sockets, nuts, and bolts can be tightened or loosened by the driving member 2. By controlling the handle 13 to rotate in the −A direction shown in FIG. 6, taking the axis of the driving member 2 as the rotation center, the tooth portion 3 may slip relative to the third pawl 51 and the fourth pawl 52. Therefore, the wrench body 1 can rotate alone in the −A direction shown in FIG. 6, while the tooth portion 3 and the driving member 2 may remain fixed relative to components such as sockets, nuts, and bolts.

As shown in FIG. 3 to FIG. 8, in an embodiment, the wrench body 1 may have a recess 11 and two limiting grooves 12 extending outward from an inner peripheral wall of the recess 11. The tooth portion 3 may be rotatably disposed in the recess 11. The first pawl 41 and the third pawl 51 may be movably disposed in one of the limiting grooves 12, and the second pawl 42 and the fourth pawl 52 may be movably disposed in another one of the limiting grooves 12. An elastic member 7 may be disposed between the first pawl 41 and the third pawl 51. When the first pawl 41 or the third pawl 51 is disengaged from the tooth portion 3, the first pawl 41 may move toward the third pawl 51 or the third pawl 51 may move toward the first pawl 41, such that the corresponding elastic member 7 may be further compressed. An elastic member 7 may be disposed between the second pawl 42 and the fourth pawl 52. When the second pawl 42 or the fourth pawl 52 is disengaged from the tooth portion 3, the second pawl 42 may move toward the fourth pawl 52 or the fourth pawl 52 may move toward the second pawl 42, such that the corresponding elastic member 7 may be further compressed.

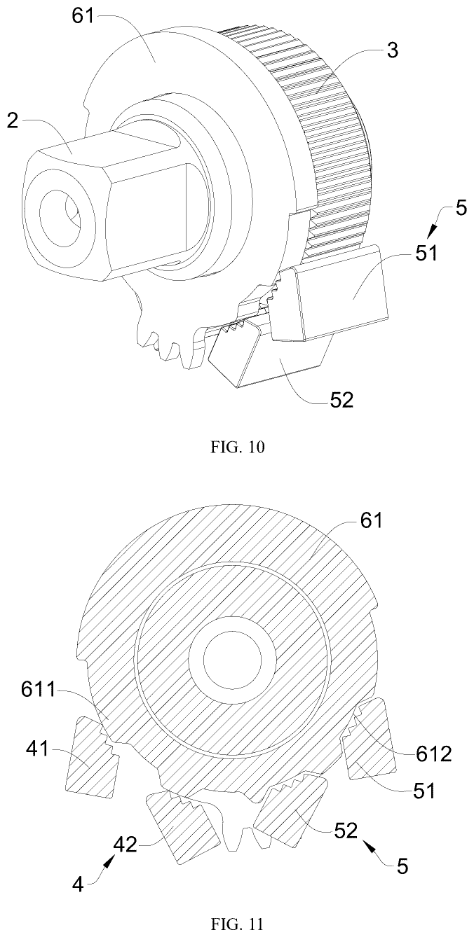

As shown in FIG. 9 to FIG. 11, in another embodiment, the wrench body 1 may include four limiting grooves 12 extending outward from the inner circumferential wall of the recess 11. The first pawl 41, the second pawl 42, the third pawl 51, and the fourth pawl 52 may be sequentially and slidably disposed in the four limiting grooves 12 along the circumferential direction of the tooth portion 3. An elastic member 7 may be disposed between each pawl and the inner wall of the corresponding limiting groove 12. When the first pawl 41, the second pawl 42, the third pawl 51, or the fourth pawl 52 are disengaged from the tooth portion 3, the first pawl 41, the second pawl 42, the third pawl 51, or the fourth pawl 52 may move toward a side away from the tooth portion 3, such that the corresponding elastic member 7 may be further compressed.

As shown in FIG. 7 to FIG. 8 and FIG. 10 to FIG. 11, the reversing assembly 6 may include a reversing member 61 rotatably disposed in the recess 11. The reversing member 61 may be coaxially disposed with the tooth portion 3 and can rotate in the ±A direction shown in FIG. 4. When the reversing member 61 rotates, the positions of the first pawl assembly 4 and the second pawl assembly 5 can be changed, such that at least one of the first pawl assembly 4 and the second pawl assembly 5 can be engaged with the tooth portion 3. As shown in FIG. 3, FIG. 5, and FIG. 9, the reversing assembly 6 may further include a driving portion 62 rotatably disposed in the limiting groove 12. The driving portion 62 may be in engaged transmission with the reversing member 61 via teeth, and the driving portion 62 may rotate about its own axis in the ±B direction shown in FIG. 3. Since the first pawl assembly 4 and the second pawl assembly 5 are arranged along the circumferential direction of the tooth portion 3, the coaxial arrangement of the reversing member 61 and the tooth portion 3 may facilitate controlling the engagement of the first pawl assembly 4 and the second pawl assembly 5 with the tooth portion 3. The interference with the tooth portion 3 or the driving member 2 that would otherwise result from directly driving the reversing member 61 can be avoided by driving the reversing member 61 via the engagement between the driving portion 62 and the reversing member 61.

As shown in FIG. 7 to FIG. 8 and FIG. 10 to FIG. 11, an outer periphery of the reversing member 61 may include a protruding portion 611 and a recessed portion 612. The protruding portion 611 may be configured to, together with the limiting groove 12, form a limiting space 601 for limiting engagement of the first pawl assembly 4 or the second pawl assembly 5 with the tooth portion 3. The recessed portion 612 may be configured to, together with the limiting groove 12, form an engaging space 602, to enable the first pawl assembly 4 or the second pawl assembly 5 to be engaged with the tooth portion 3. The reversing member 61 may be configured to change positions of the first pawl assembly 4 and the second pawl assembly 5 upon rotation. When the reversing member 61 rotates to a position where the first pawl 41 and the second pawl 42 are located in the limiting space 601, the protruding portion 611 may be engaged with the first pawl 41 and the second pawl 42 to push the first pawl 41 and the second pawl 42 away from the tooth portion 3 and separate the first pawl 41 and the second pawl 42 from the tooth portion 3, thereby limiting the first pawl 41 and the second pawl 42 from engaging with the tooth portion 3. The reversing member 61 may be configured to overcome the elastic force of the elastic member 7 to further compress the elastic member 7. At the same time, the third pawl 51 and the fourth pawl 52 may be located in the engaging space 602, and the recessed portion 612 may be engaged with the third pawl 51 and the fourth pawl 52, to enable the third pawl 51 and the fourth pawl 52 to move toward the tooth portion 3 under the action of the elastic member 7 and engage with the tooth portion 3.

When the reversing member 61 rotates to a position where the third pawl 51 and the fourth pawl 52 are located in the limiting space 601, the protruding portion 611 may be engaged with the third pawl 51 and the fourth pawl 52 to push the third pawl 51 and the fourth pawl 52 away from the tooth portion 3 and separate the third pawl 51 and the fourth pawl 52 from the tooth portion 3, thereby limiting the third pawl 51 and the fourth pawl 52 from engaging with the tooth portion 3. The reversing member 61 may be configured to overcome the elastic force of the elastic member 7 to further compress the elastic member 7. At the same time, the first pawl 41 and the second pawl 42 may be located in the engaging space 602, and the recessed portion 612 may be engaged with the first pawl 41 and the second pawl 42 to enable the first pawl 41 and the second pawl 42 to move toward the tooth portion 3 under the action of the elastic member 7 and engage with the tooth portion 3.

As shown in FIG. 9 and FIG. 11, the protruding portion 611 and the recessed portion 612 may be connected by an inclined surface to provide a guiding function, facilitating the reversing member 61 in pushing the pawls. Alternatively, the pawls may also be provided with inclined surfaces or guide members that can cooperate with the inclined surface between the protruding portion 611 and the recessed portion 612, so as to further facilitate the reversing member 61 in pushing the pawls. The adjustment method of switching between the engagement of the first pawl assembly 4 with the tooth portion 3 and the engagement of the second pawl assembly 5 with the tooth portion 3 via the reversing member 61 is simple and convenient, and the number of parts is small, facilitating production and assembly.

As shown in FIG. 2 to FIG. 3, the reversing assembly 6 may further include a toggle member 69 movably disposed on the wrench body 1 and connected to the driving portion 62, and at least a portion of the toggle member 69 may extend outside the wrench body 1. A user can drive the driving portion 62 to rotate inside the wrench body 1 by toggling the toggle member 69 from outside the wrench body 1, providing convenient operation.

In other words, the wrench 100 may have a first use state in which the wrench 100 rotates in the preset direction and a second use state in which the wrench 100 rotates in the direction opposite to the preset direction. In the first use state, at least a portion of ratchet teeth of the first pawl 41 may be in complete engagement with the tooth portion 3, and at least a portion of ratchet teeth of the second pawl 42 may be in incomplete engagement with the tooth portion 3. In the second use state, at least a portion of ratchet teeth of the third pawl 51 may be in complete engagement with the tooth portion 3, and at least a portion of ratchet teeth of the fourth pawl 52 may be in incomplete engagement engaged with the tooth portion 3. The toggle member 69 of the reversing assembly 6 may be configured to drive the driving portion 62 to further cause the reversing member 61 to rotate inside the wrench body 1, thereby changing the engagement positions of the first pawl 41, the second pawl 42, the third pawl 51, and the fourth pawl 52 and the tooth portion 3, so as to switch the wrench 100 between the first use state and the second use state.

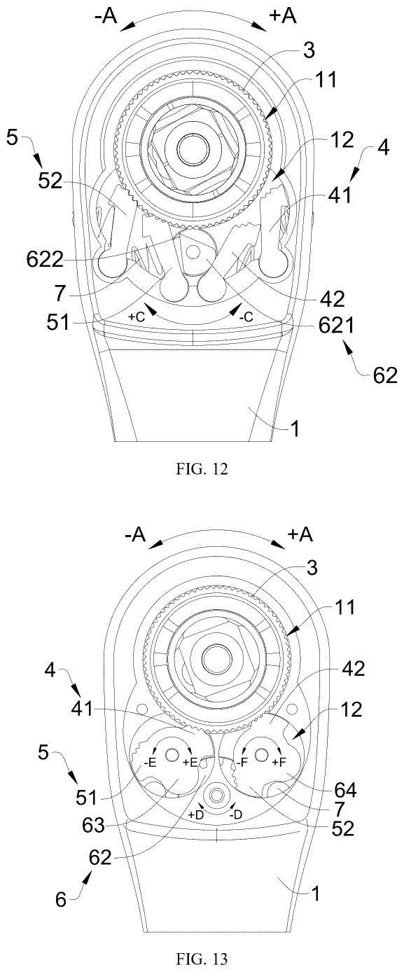

As shown in FIG. 12, in another embodiment, the wrench body 1 may further include a limiting groove 12 extending outward from the inner peripheral wall of the recess 11. The first pawl 41, the second pawl 42, the third pawl 51, and the fourth pawl 52 may be sequentially disposed in the limiting groove 12 along the circumferential direction of the tooth portion 3, each pawl can rotate along its own axis, and an elastic member 7 may be disposed between each pawl and the inner wall of the limiting groove 12. The reversing assembly 6 may include a driving portion 62 rotatably disposed in the limiting groove 12, and the driving portion 62 may be configured to rotate about its own axis in the ±C direction shown in FIG. 12. The driving portion 62 may be located between the second pawl 42 and the third pawl 51. The outer periphery of the driving portion 62 may include a convex portion 621 and a concave portion 622 that can cooperate with the second pawl 42 and the third pawl 51. When the driving portion 62 rotates to a position where the convex portion 621 is engaged with the second pawl 42, the convex portion 621 can push the second pawl 42 away from the tooth portion 3 such that the second pawl 42 is separated from the tooth portion 3, and the second pawl 42 can push the first pawl 41 away from the tooth portion 3 such that the first pawl 41 is separated from the tooth portion 3. The driving part 62 may be configured to overcome the elastic force of the elastic member 7 to further compress the elastic member 7. At the same time, the concave portion 622 may be corresponding to the third pawl 51. The third pawl 51 may be in contact with the concave portion 622 or spaced from the concave portion 622 by a distance. The third pawl 51 and the fourth pawl 52 may move toward the tooth portion 3 under the action of the elastic member 7 and can be engaged with the tooth portion 3. When the driving portion 62 rotates to a position where the convex portion 621 is engaged with the third pawl 51, the convex portion 621 can push the third pawl 51 away from the tooth portion 3 such that the third pawl 51 is separated from the tooth portion 3, and the third pawl 51 can push the fourth pawl 52 away from the tooth portion 3 such that the fourth pawl 52 is separated from the tooth portion 3. The driving portion 62 may be configured to overcome the elastic force of the elastic member 7 to further compress the elastic member 7. At the same time, the concave portion 622 may be corresponding to the second pawl 42. The second pawl 42 may be in contact with the concave portion 622 or spaced from the concave portion 622 by a distance. The first pawl 41 and the second pawl 42 may move toward the tooth portion 3 under the action of the elastic member 7 and can be engaged with the tooth portion 3.

As shown in FIG. 2 and FIG. 12, the reversing assembly 6 may further include a toggle member 69 movably disposed on the wrench body 1 and connected to the reversing member 61, and at least a portion of the toggle member 69 may extend outside the wrench body 1. A user can drive the reversing member 61 to rotate inside the wrench body 1 by toggling the toggle member 69 from outside the wrench body 1, providing convenient operation. Furthermore, the operating portion 14 may further include a closure plate 141, and the closure plate 141 may be configured to close one side of the recess 11 and the limiting groove 12, so as to prevent the tooth portion 3 and the reversing assembly 6 from being separated.

Each of the elastic members 7 may be configured as an elastic element such as a spring, a rubber member, or a silicone member, which is not specifically limited herein.

As shown in FIG. 13 to FIG. 16, in other embodiments, the wrench body 1 may also be provided with two limiting grooves 12 extending outward from the inner peripheral wall of the recess 11. The reversing assembly 6 may include a first rotating member 63 and a second rotating member 64 respectively disposed in the two limiting grooves 12 and capable of rotating synchronously around their own axes. The first rotating member 63 may be configured to rotate in ±E direction shown in FIG. 13, and the second rotating member 64 may be configured to rotate in ±F direction shown in FIG. 13. The first pawl 41 and the third pawl 51 may be spaced apart on an outer periphery of the first rotating member 63, and the second pawl 42 and the fourth pawl 52 may be spaced apart on an outer periphery of the second rotating member 64. The inner walls of the two limiting grooves 12 are respectively provided with a groove, and an elastic member 7 such as an elastic ball or an elastic protrusion may be disposed in the groove. A portion of the elastic ball or an end portion of the elastic ball may protrude from the groove. When the first rotating member 63 or the second rotating member 64 presses the elastic ball during rotation, the elastic ball can be compressed within the groove and apply an elastic force to the first rotating member 63 or the second rotating member 64, such that the first rotating member 63 or the second rotating member 64 may have a tendency to rotate in the opposite direction.

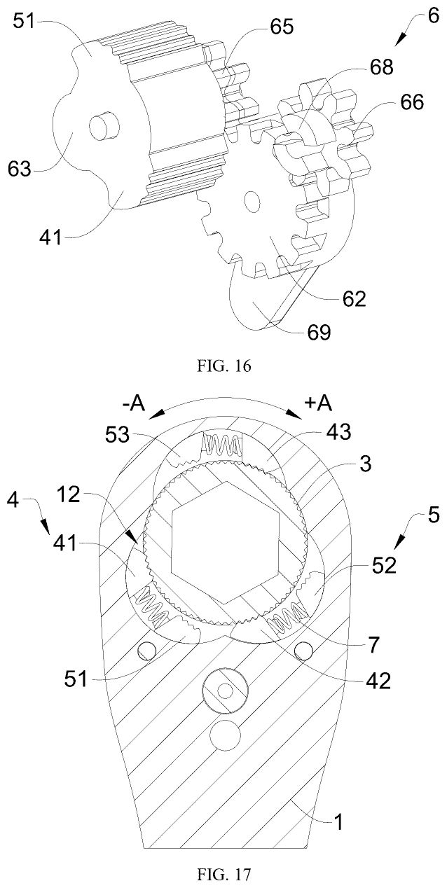

As shown in FIG. 16, the reversing assembly 6 may further include a first transmission member 65 disposed on the first rotating member 63 and a second transmission member 66 disposed on the second rotating member 64. The first transmission member 65 may be coaxially arranged with the first rotating member 63, and the first transmission member 65 can rotate about its own axis. The second transmission member 66 may be coaxially arranged with the second rotating member 64, and the second transmission member 66 can rotate about its own axis. The wrench body 1 may further include a driving groove in communication with the two limiting grooves 12, and the reversing assembly 6 may further include a driving portion 62 rotatably disposed in the driving groove. The driving portion 62 may be engaged transmission with the first transmission member 65 and the second transmission member 66 via teeth, and the driving portion 62 may be configured to rotate about its own axis in the ±D direction shown in FIG. 13. The adjustment method of switching between the engagement of the first pawl assembly 4 with the tooth portion 3 and the engagement of the second pawl assembly 5 with the tooth portion 3 through the rotations of the first rotating member 63 and the second rotating member 64 is simple and convenient. In addition, by controlling the rotations of the first rotating member 63 and the second rotating member 64 by a gear meshing transmission method, it may be ensured that the first rotating member 63 and the second rotating member 64 can rotate synchronously. The gear structure is simple, and production and processing are facilitated. The reversing assembly 6 may further include a toggle member 69 connected to the driving portion 62. At least a portion of the toggle member 69 may extend outside the wrench body 1. The toggle member 69 can rotate about its own axis in the ±D direction shown in FIG. 13. A user can drive the driving portion 62 to rotate inside the wrench body 1 by toggling the toggle member 69 from outside the wrench body 1, providing convenient operation.

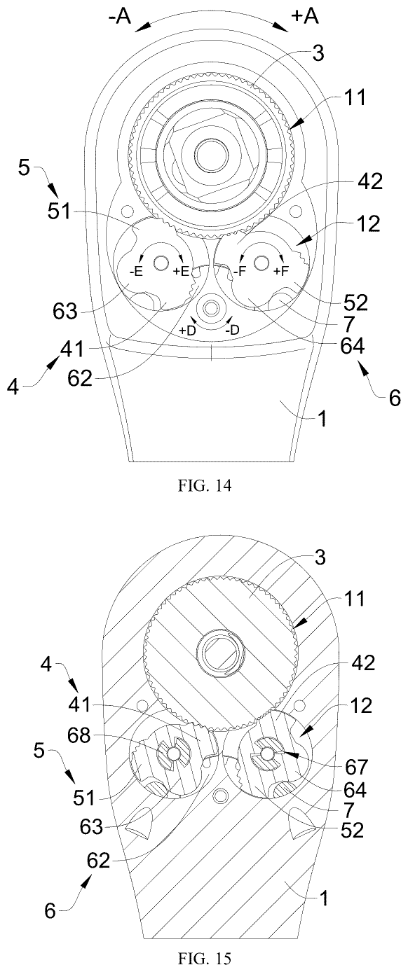

As shown in FIG. 13 to FIG. 14, when the user rotates the toggle member 69 in the +D direction, the toggle member 69 can drive the driving portion 62 to rotate in the +D direction. The driving portion 62 can drive the first transmission member 65 to rotate in the −E direction and drive the second transmission member 66 to rotate in the −F direction simultaneously, thereby driving the first rotating member 63 to rotate in the −E direction and driving the second rotating member 64 to rotate in the −F direction simultaneously. Thus, the first pawl 41 and the second pawl 42 can be engaged with the tooth portion 3. When the user rotates the toggle member 69 in the −D direction, the toggle member 69 can drive the driving portion 62 to rotate in the −D direction. The driving portion 62 can drive the first transmission member 65 to rotate in the +E direction and drive the second transmission member 66 to rotate in the +F direction simultaneously, thereby driving the first rotating member 63 to rotate in the +E direction and driving the second rotating member 64 to rotate in the +F direction simultaneously. Thus, the third pawl 51 and the fourth pawl 52 can be engaged with the tooth portion 3.

As shown in FIG. 13, when the first pawl 41 and the second pawl 42 can be engaged with the tooth portion 3, the tooth portion 3 can rotate in the −A direction. At this time, when the tooth tip of the tooth portion 3 is opposite to the tooth tip of the first pawl 41 or the second pawl 42, the tooth portion 3 may push the first rotating member 63 to rotate in the +E direction or push the second rotating member 64 to rotate in the +F direction, causing the first pawl 41 or the second pawl 42 to be disengaged from the tooth portion 3 and slip relative to the tooth portion 3. An elastic ball corresponding to the first rotating member 63 or the second rotating member 64 may be compressed and may apply an elastic force to the first rotating member 63 or the second rotating member 64, such that the first rotating member 63 may have a tendency to rotate in the −E direction or the second rotating member 64 may have a tendency to rotate in the −F direction. When the tooth tip of the first pawl 41 or the second pawl 42 corresponds to the tooth groove of the tooth portion 3, under the action of the elastic ball, the first rotating member 63 can be pushed to rotate in the −E direction or the second rotating member 64 can be pushed to rotate in the −F direction, such that the first pawl 41 or the second pawl 42 is engaged with the tooth portion 3. When the first rotating member 63 and the second rotating member 64 abut against the inner wall of the limiting groove 12, the tooth portion 3 can be limited to rotate. At this time, the wrench body 1 can drive the tooth portion 3 and the driving member 2 to rotate synchronously in the +A direction, so as to tighten or loosen components such as sockets, nuts and bolts.

As shown in FIG. 14, when the third pawl 51 and the fourth pawl 52 can be engaged with the tooth portion 3, the tooth portion 3 can rotate in the +A direction. At this time, when the tooth tip of the tooth portion 3 is opposite to the tooth tip of the third pawl 51 or the fourth pawl 52, the tooth portion 3 may push the first rotating member 63 to rotate in the −E direction or push the second rotating member 64 to rotate in the −F direction, causing the third pawl 51 or the fourth pawl 52 to be disengaged from the tooth portion 3 and slip relative to the tooth portion 3. An elastic ball corresponding to the first rotating member 63 or the second rotating member 64 may be compressed and may apply an elastic force to the first rotating member 63 or the second rotating member 64, such that the first rotating member 63 may have a tendency to rotate in the +E direction or the second rotating member 64 may have a tendency to rotate in the +F direction. When the tooth tip of the third pawl 51 or the fourth pawl 52 corresponds to the tooth groove of the tooth portion 3, under the action of the elastic ball, the first rotating member 63 can be pushed to rotate in the +E direction or the second rotating member 64 can be pushed to rotate in the +F direction, such that the third pawl 51 or the fourth pawl 52 is engaged with the tooth portion 3. When the first rotating member 63 and the second rotating member 64 abut against the inner wall of the limiting groove 12, the tooth portion 3 can be limited to rotate. At this time, the wrench body 1 can drive the tooth portion 3 and the driving member 2 to rotate synchronously in the −A direction, so as to tighten or loosen components such as sockets, nuts, and bolts.

As shown in FIG. 15 to FIG. 16, each of the first rotating member 63 and the second rotating member 64 may be provided with an arc-shaped groove 67. The arc-shaped groove 67 of the first rotating member 63 may be concentrically arranged with the first rotating member 63, and the arc-shaped groove 67 of the second rotating member 64 may be concentrically arranged with the second rotating member 64. Each of the first transmission member 65 and the second transmission member 66 may be provided with an arc-shaped block 68 capable of being snapped into the arc-shaped groove 67. The arc-shaped block 68 may be in clearance fit with the arc-shaped groove 67. Thus, a certain rotational clearance may be provided between the first rotating member 63 and the first transmission member 65 and between the second rotating member 64 and the second transmission member 66, such that when the pawl slips relative to the tooth portion 3, the first rotating member 63 and the second rotating member 64 can rotate independently without driving the first transmission member 65 and the second transmission member 66 to rotate, thereby preventing one of the first transmission member 65 and the second transmission member 66 from being driven by the first rotating member 63 or the second rotating member 64 to rotate the driving portion 62, which would otherwise cause the other one of the first transmission member 65 and the second transmission member 66 to rotate synchronously and affect normal engagement between the pawl and the tooth portion 3. When the first transmission member 65 and the second transmission member 66 rotate, the side wall of the arc-shaped groove 67 can be pushed by the arc-shaped block 68 to drive the first rotating member 63 and the second rotating member 64 to rotate.

As shown in FIG. 15 to FIG. 16, in the illustrated embodiment, each of the first rotating member 63 and the second rotating member 64 may be provided with two arc-shaped grooves 67. Each of the first transmission member 65 and the second transmission member 66 may be provided with two arc-shaped blocks 68 corresponding to the arc-shaped grooves 67, and the two arc-shaped grooves 67 may be oppositely arranged to improve stability and reliability of the connection between the first rotating member 63 and the first transmission member 65 and between the second rotating member 64 and the second transmission member 66. In other embodiments, each of the first rotating member 63 and the second rotating member 64 may be provided with one, three, or more arc-shaped grooves 67. Each of the first rotating member 63 and the second rotating member 64 may also be provided with different numbers of arc-shaped grooves 67. Each of the first transmission member 65 and the second transmission member 66 may be provided with arc-shaped blocks 68 corresponding to the arc-shaped grooves 67 in number and position. When the first rotating member 63 or the second rotating member 64 is provided with a plurality of arc-shaped grooves 67, the plurality of arc-shaped grooves 67 may be evenly spaced along the circumferential direction of the first rotating member 63 or the second rotating member 64, so as to ensure the stability and reliability of the connection between the first rotating member 63 and the first transmission member 65 and between the second rotating member 64 and the second transmission member 66.

As shown in FIG. 17, the first pawl assembly 4 may further include a fifth pawl 43 being engageable with the tooth portion 3. The first pawl 41, the second pawl 42, and the fifth pawl 43 may be spaced apart along the outer periphery of the tooth portion 3. When the first pawl 41 or the second pawl 42 is engaged with the tooth portion 3, the fifth pawl 43 may be in the state of incomplete engagement with the tooth portion 3. The second pawl assembly 5 may further include a sixth pawl 53 being engageable with the tooth portion 3. The third pawl 51, the fourth pawl 52, and the sixth pawl 53 may be spaced apart along the outer periphery of the tooth portion 3. When the third pawl 51 or the fourth pawl 52 is engaged with the tooth portion 3, the sixth pawl 53 may be in the state of incomplete engagement with the tooth portion 3.

In an embodiment, under the condition that three pawl assemblies are evenly distributed along the recess 11, when the reversing assembly 6 controls the first pawl assembly 4 to be engaged with the tooth portion 3, one of the first pawl 41, the second pawl 42, and the fifth pawl 43 may be in complete engagement with the tooth portion 3, while the other two of the first pawl 41, the second pawl 42, and the fifth pawl 43 may be engaged with the tooth portion 3 by ⅔ and ⅓ portions, respectively. When the reversing assembly 6 controls the second pawl assembly 5 to be engaged with the tooth portion 3, one of the third pawl 51, the fourth pawl 52, and the sixth pawl 53 may be in complete engagement with the tooth portion 3, while the other two of the third pawl 51, the fourth pawl 52, and the sixth pawl 53 may be engaged with the tooth portion 3 by ⅔ and ⅓ portions, respectively. In this way, an effect of more times of teeth can be achieved, thereby allowing the wrench 100 to be used in an even narrower operating space, and further expanding the application range of the wrench 100. The engagement ratios of the three pawls can also be changed according to actual application requirements. In other embodiments, each of the first pawl assembly 4 and the second pawl assembly 5 may include four pawls, five pawls, or more pawls, with the plurality of pawls arranged at intervals along the outer periphery of the tooth portion 3, which is not specifically limited herein.

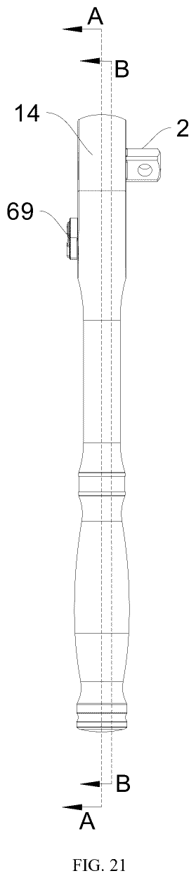

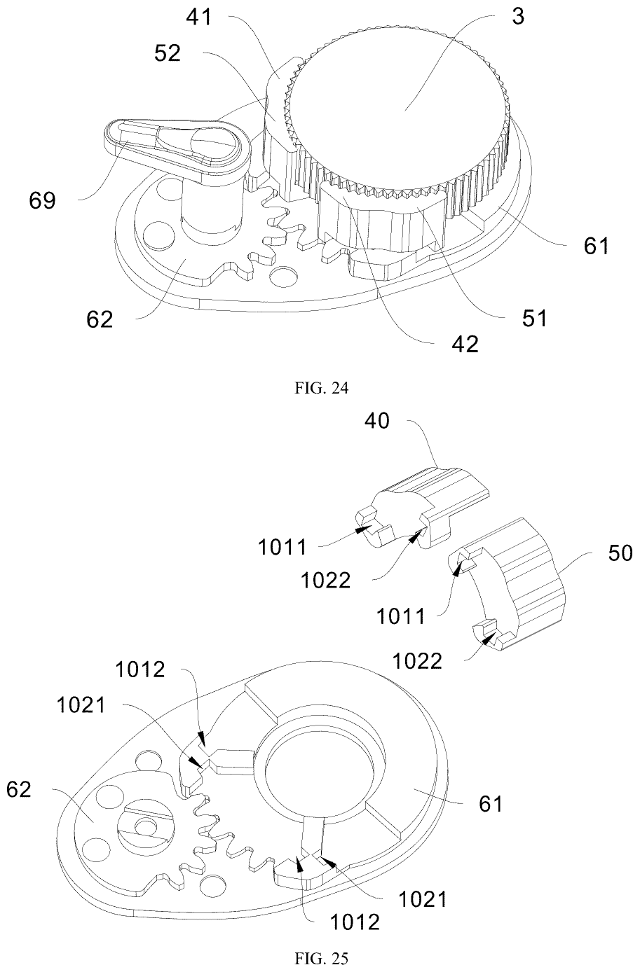

As shown in FIG. 19 to FIG. 27, in an embodiment, the first pawl 41 and the fourth pawl 52 may be integrally formed as a first tooth block 40, and ratchet teeth 405 of the first pawl 41 and ratchet teeth 405 of the fourth pawl 52 may be sequentially arranged along a first radius of curvature on a side of the first tooth block 40 proximal to the tooth portion 3. The second pawl 42 and the third pawl 51 may be integrally formed as a second tooth block 50, and ratchet teeth 405 of the second pawl 42 and ratchet teeth 405 of the third pawl 51 may be sequentially arranged along a second radius of curvature on a side of the second tooth block 50 proximal to the tooth portion 3. The first radius of curvature may be greater than a radius of curvature of the tooth portion 3, and the second radius of curvature may be greater than the radius of curvature of the tooth portion 3. In other words, the ratchet teeth 405 of the first pawl 41 and the ratchet teeth 405 of the fourth pawl 52 may be sequentially arranged along a first curvature on the side of the first tooth block 40 proximal to the tooth portion 3, and the ratchet teeth 405 of the second pawl 42 and the ratchet teeth 405 of the third pawl 51 may be sequentially arranged along a second curvature on the side of the second tooth block 50 proximal to the tooth portion 3. The first curvature may be smaller than a curvature of the tooth portion 3, and the second curvature may be smaller than the curvature of the tooth portion 3. By this configuration, the synchronization of the first pawl assembly 4 and the second pawl assembly 5 is improved, the number of structural members is effectively reduced, the assembly is convenient, and the cooperation between the first pawl assembly 4 and the second pawl assembly 5 and the reversing assembly 6 is simpler and more stable, making direction switching easier to control. That is, the fact that the first radius of curvature of the first tooth block 40 is greater than the radius of curvature of the tooth portion 3 enables a portion of the ratchet teeth of the first tooth block 40 to be engaged with the tooth portion 3 and another portion of the ratchet teeth of the first tooth block 40 can be disengaged or partially disengaged from the tooth portion 3. Similarly, the fact that the second radius of curvature of the second tooth block 50 is greater than the radius of curvature of the tooth portion 3 enables a portion of the ratchet teeth of the second tooth block 50 to be engaged with the tooth portion 3 and another portion of the ratchet teeth of the second tooth block 50 can be disengaged or partially disengaged from the tooth portion 3.

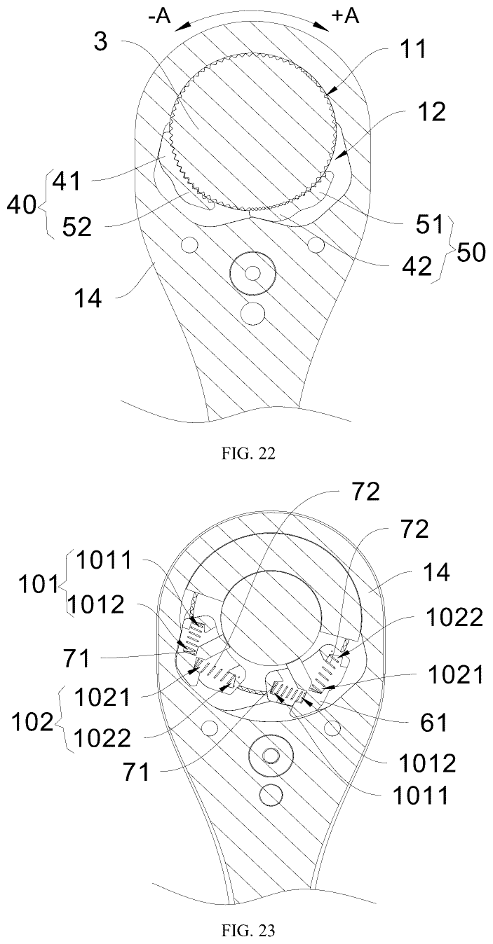

In other words, as shown in FIG. 19 and FIG. 21 to FIG. 25, when the ratchet teeth of the first pawl 41 of the first tooth block 40 are engaged with the tooth portion 3, and the ratchet teeth of the second pawl 42 of the second tooth block 50 are in incomplete engagement with the tooth portion 3, the ratchet teeth of the fourth pawl 52 and the ratchet teeth of the third pawl 51 may be disengaged or partially disengaged from the tooth portion 3, such that the wrench body 1 and the driving member 2 can rotate synchronously in the preset direction (i.e., rotating in the −A direction as shown in FIG. 22, taking the axis of the driving member 2 as the rotation center). Thus, the driving member 2 can tighten or loosen components such as sockets, nuts, and bolts in the −A direction. When the handle 13 is controlled to rotate in the +A direction shown in FIG. 22, taking the axis of the driving member 2 as the rotation center, since the tooth portion 3 is engaged with the first tooth block 40 and the second tooth block 50 via the ratchet teeth, the tooth portion 3 may slip relative to the first pawl 41 and the second pawl 42, and the wrench body 1 can rotate alone in the +A direction shown in FIG. 22, while the tooth portion 3 and the driving member 2 may remain fixed relative to components such as sockets, nuts, and bolts. Thus, by repeatedly rotating and reversing the operating portion 14 by controlling the handle 13, the force can be continuously applied to the components such as the sockets, nuts, and bolts, gradually tightening these components to the required fastening standard.

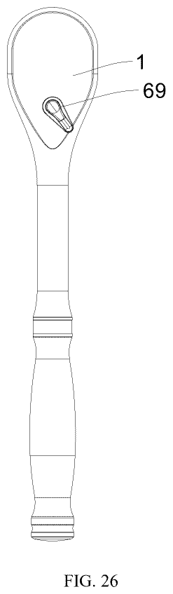

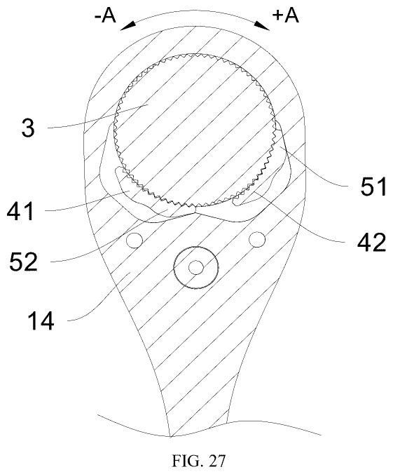

Referring to FIG. 26 and FIG. 27, on the contrary, when the reversing member 61 is toggled such that the ratchet teeth of the fourth pawl 52 of the first tooth block 40 is incompletely engaged with the tooth portion 3 and the ratchet teeth of the third pawl 51 of the second tooth block 50 is engaged with the tooth portion 3, the ratchet teeth of the first pawl 41 and the ratchet teeth of the second pawl 42 may be disengaged or partially disengaged from the tooth portion 3, such that the wrench body 1 and the driving member 2 can rotate synchronously in the direction opposite to the preset direction (i.e., rotating in the +A direction as shown in FIG. 27, taking the axis of the driving member 2 as the rotation center). At this time, the driving member 2 can tighten or loosen components such as sockets, nuts, and bolts in the +A direction. When the handle 13 is controlled to rotate in the −A direction shown in FIG. 27, taking the axis of the driving member 2 as the rotation center, the tooth portion 3 may slip relative to the third pawl 51 and the fourth pawl 52, and the wrench body 1 can rotate alone in the −A direction shown in FIG. 22, while the tooth portion 3 and the driving member 2 remain fixed relative to components such as sockets, nuts, and bolts. Thus, by repeatedly rotating and reversing the operating portion 14 by controlling the handle 13, the force can be continuously applied to the components such as the sockets, nuts, and bolts, gradually tightening these components to the required fastening standard.

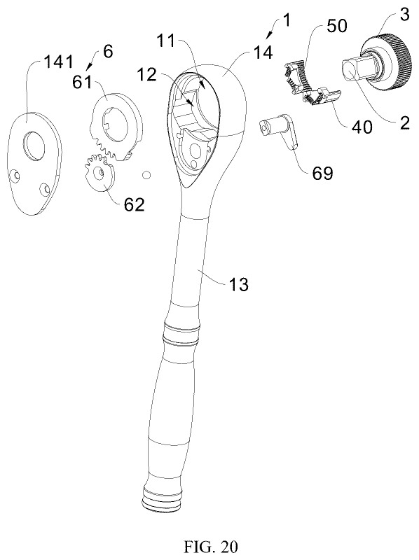

As shown in FIG. 20 to FIG. 25, a set of first mounting grooves 101 and second mounting grooves 102 arranged in a V-shape is provided both between the first tooth block 40 and the reversing member 61 and between the second tooth block 50 and the reversing member 61, and one of the elastic members 7 may be provided in each mounting groove of the set of first mounting grooves 101 and the second mounting grooves 102. When the reversing member 61 is rotated in the preset direction or in the direction opposite to the preset direction, a groove distance of the first mounting grooves 101 in each set of first mounting grooves 101 and the second mounting grooves 102 along an arrangement direction of the elastic members 7 is shortened, or a groove distance of the second mounting grooves 102 in each set of first mounting grooves 101 and the second mounting grooves 102 along the arrangement direction of the elastic members 7 is shortened, so as to compress the elastic members 7, thereby causing a portion of the ratchet teeth 405 of one of the first tooth block 40 and the second tooth block 50 to be engaged with the tooth portion 3, and a portion of the ratchet teeth 405 of another of the first tooth block 40 and the second tooth block 50 to be incompletely engaged with the tooth portion 3.

In other words, a set of elastic members 7 may be provided both between the first tooth block 40 and the reversing member 61 and between the second tooth block 50 and the reversing member 61. Each set of elastic members 7 may include a first elastic member 71 and a second elastic member 72 arranged in a V-shape. When the reversing member 61 is rotated in the preset direction or in the direction opposite to the preset direction, the two first elastic members 71 or the two second elastic members 72 can be compressed. Thus, a portion of the ratchet teeth 405 of one of the first tooth block 40 and the second tooth block 50 may be engaged with the tooth portion 3, and a portion of the ratchet teeth 405 of another one of the first tooth block 40 and the second tooth block 50 may be in incomplete engagement with the tooth portion 3.

By this configuration, since each of the first radius of curvature and the second radius of curvature is greater than the radius of curvature of the tooth portion 3, the reversing member 61 can compress the elastic members 7 in the first mounting groove 101 or the second mounting groove 102 when reversing, such that one side of the first tooth block 40 and one side of the second tooth block 50 may be subjected to the elastic action of the elastic members 7 and rotate toward the tooth portion 3. Thus, one of a portion of the ratchet teeth 405 of the first tooth block 40 and a portion of the ratchet teeth 405 of the second tooth block 50 can be engaged with the tooth portion 3, and another one of the portion of the ratchet teeth 405 of the first tooth block 40 and the portion of the ratchet teeth 405 of the second tooth block 50 can be incompletely engaged with the tooth portion 3. Meanwhile, another side of the first tooth block 40 and another side of the second tooth block 50 rotate in the opposite direction and tilt upward, moving away from the tooth portion 3, thereby being disengaged or partially disengaged from the tooth portion 3.

Specifically, the first elastic member 71 may be disposed in the first mounting groove 101, and the second elastic member 72 may be disposed in the second mounting groove 102.

In this embodiment, in order to maintain better synchronization of the driving cooperation on the two sides, the first radius of curvature may be equal to the second radius of curvature, i.e., the first curvature may be equal to the second curvature.

As shown in FIG. 23 to FIG. 25, the first mounting groove 101 may include a first groove portion 1011 and a second groove portion 1012 with their openings facing each other. The second mounting groove 102 may include a third groove portion 1021 and a fourth groove portion 1022 with their openings facing each other. The first groove portion 1011 and the fourth groove portion 1022 may be provided on sides of the first tooth block 40 and the second tooth block 50 facing the reversing member 61, and the second groove portion 1012 and the third groove portion 1021 may be correspondingly provided on a side of the reversing member 61 facing the first tooth block 40 and the second tooth block 50.

Referring to FIG. 22 and FIG. 23, when the wrench body 1 rotates in the preset direction, the two second groove portions 1012 on the reversing member 61 may approach to the two first groove portions 1011, respectively, shortening a groove distance of the first mounting grooves 101. The two elastic members 7 located in the two first mounting grooves 101 may be compressed, thereby applying an elastic force to a side of the first tooth block 40 relatively away from the second tooth block 50 and a side of the second tooth block 50 relatively proximal to the first tooth block 40, such that portion of the ratchet teeth of the first tooth block 40 may be engaged with the tooth portion 3, and a portion of the ratchet teeth of the second tooth block 50 may be incompletely engaged with the tooth portion 3.

At the same time, the two third groove portions 1021 may move away from the two fourth groove portions 1022, respectively, lengthening the groove distance of the second mounting grooves 102. The compression of the two elastic members 7 located in the two second mounting grooves 102 may be restored, and no elastic force may be applied to the first tooth block 40 and the second tooth block 50. Thus, another side of the first tooth block 40 and another side of the second tooth block 50 may rotate in the opposite direction, thereby being disengaged or partially disengaged from the tooth portion 3.

The various technical features of the embodiments described above can be combined arbitrarily. For brevity of description, not all possible combinations of the technical features in the above embodiments have not been described. However, these combinations of technical features should be construed as falling within the scope of the specification as long as no contradiction occurs.

The above embodiments described above only represent several implementations of the present disclosure. The description thereof is relatively specific and detailed, but should not be construed as limiting the scope of the present disclosure. It should be noted that, for those skilled in the art, several modifications and improvements may be made without departing from the concept of the present disclosure, which all fall within the protection scope of the present disclosure. Therefore, the protection scope of the present disclosure shall be defined by the appended claims.

What is claimed is:

1. A wrench, comprising a wrench body, a driving member, a tooth portion, a first pawl assembly, and elastic members, wherein
the driving member is rotatably disposed on the wrench body and configured to drive an external element;
the tooth portion is coaxially disposed on a side surface of the driving member and rotatable synchronously with the driving member;
the first pawl assembly is movably disposed on the wrench body, the first pawl assembly comprises a first pawl and a second pawl arranged along a circumferential direction of the tooth portion, each of the first pawl and the second pawl is configured to be engaged with the tooth portion, such that the driving member rotates synchronously with the wrench body in a preset direction, when at least a portion of the first pawl is engaged with the tooth portion, at least a portion of the second pawl is in a state of incomplete engagement with the tooth portion; and
the elastic members are configured to apply an elastic force to the first pawl and the second pawl, such that at least a portion of the first pawl and at least a portion of the second pawl both have a tendency to move toward a side proximal to the tooth portion.

2. The wrench of claim 1, further comprising a second pawl assembly and a reversing assembly, wherein
the second pawl assembly is movably disposed on the wrench body, and the second pawl assembly is configured to be engaged with the tooth portion, such that the driving member and the wrench body rotate synchronously in a direction opposite to the preset direction; and
the reversing assembly is disposed on the wrench body and configured to change positions of the first pawl assembly and the second pawl assembly, such that at least one of the first pawl assembly and the second pawl assembly is engageable with the tooth portion.

3. The wrench of claim 2, wherein the second pawl assembly comprises a third pawl and a fourth pawl arranged along the circumferential direction of the tooth portion, each of the third pawl and the fourth pawl is configured to be engaged with the tooth portion; and
when at least a portion of the third pawl is engaged with the tooth portion, at least a portion of the fourth pawl is in a state of incomplete engagement with the tooth portion.

4. The wrench of claim 3, wherein the wrench body has a recess and a limiting groove extending outward from an inner peripheral wall of the recess, the tooth portion is rotatably disposed in the recess, and the first pawl assembly and the second pawl assembly are movably disposed in the limiting groove;
when the wrench body rotates in the preset direction, the first pawl assembly is in engagement with the tooth portion, and when the first pawl assembly abuts against the inner wall of the limiting groove, the first pawl assembly is prevented from disengaging from the tooth portion, such that the driving member rotates synchronously with the wrench body; and
when the wrench body rotates in the direction opposite to the preset direction, the second pawl assembly is in engagement with the tooth portion, and when the second pawl assembly abuts against the inner wall of the limiting groove, the second pawl assembly is prevented from disengaging from the tooth portion, such that the driving member rotates synchronously with the wrench body.

5. The wrench of claim 4, wherein the reversing assembly comprises a reversing member rotatably disposed on the wrench body and coaxially disposed with the tooth portion, and the reversing member is configured to change the positions of the first pawl assembly and the second pawl assembly upon rotation, such that at least one of the first pawl assembly and the second pawl assembly is engageable with the tooth portion.

6. The wrench of claim 5, wherein the reversing assembly further comprises a driving portion rotatably disposed in the limiting groove, and the driving portion is in engaged transmission with the reversing member via teeth.

7. The wrench of claim 5, wherein an outer periphery of the reversing member comprises a protruding portion and a recessed portion;
the protruding portion is configured to, together with the limiting groove, form a limiting space for limiting engagement of the first pawl assembly or the second pawl assembly with the tooth portion; and
the recessed portion is configured to, together with the limiting groove, form an engaging space, to enable the first pawl assembly or the second pawl assembly to be engaged with the tooth portion.

8. The wrench of claim 5, wherein the first pawl and the fourth pawl are integrally formed as a first tooth block, and ratchet teeth of the first pawl and ratchet teeth of the fourth pawl are sequentially arranged along a first radius of curvature on a side of the first toothed block proximal to the tooth portion;
the second pawl and the third pawl are integrally formed as a second tooth block, and ratchet teeth of the second pawl and ratchet teeth of the third pawl are sequentially arranged along a second radius of curvature on a side of the second tooth block proximal to the tooth portion; and
the first radius of curvature is greater than a radius of curvature of the tooth portion, and the second radius of curvature is greater than the radius of curvature of the tooth portion.

9. The wrench of claim 8, wherein a set of first mounting grooves and second mounting grooves arranged in a V-shape is provided both between the first tooth block and the reversing member and between the second tooth block and the reversing member, and one of the elastic members is provided in each mounting groove of the set of first mounting grooves and second mounting grooves; when the reversing member is rotated in the preset direction or in the direction opposite to the preset direction, a groove distance of the first mounting grooves in each set of first mounting grooves and second mounting grooves along an arrangement direction of the elastic members is shortened, or a groove distance of the second mounting grooves in each set of first mounting grooves and second mounting grooves along the arrangement direction of the elastic members is shortened, so as to compress the elastic members, thereby causing a portion of the ratchet teeth of one of the first tooth block and the second tooth block to be engaged with the tooth portion, and a portion of the ratchet teeth of another of the first tooth block and the second tooth block to be incompletely engaged with the tooth portion.

10. The wrench of claim 4, wherein the reversing assembly further comprises a driving portion rotatably disposed in the limiting groove, and the driving portion is configured to change the positions of the first pawl assembly and the second pawl assembly upon rotation, such that at least one of the first pawl assembly and the second pawl assembly is engageable with the tooth portion.

11. The wrench of claim 10, wherein the reversing assembly further comprises a first rotating member and a second rotating member disposed in the limiting groove, and the driving portion is further configured to drive the first rotating member and the second rotating member to rotate synchronously; and
the first pawl and the third pawl are spaced apart on an outer periphery of the first rotating member, and the second pawl and the fourth pawl are spaced apart on an outer periphery of the second rotating member.

12. The wrench of claim 11, wherein the reversing assembly further comprises a first transmission member disposed on the first rotating member and a second transmission member disposed on the second rotating member, and the driving portion is in engaged transmission with the first transmission member and the second transmission member via teeth.

13. The wrench of claim 12, wherein each of the first rotating member and the second rotating member is provided with an arc-shaped groove, and each of the first transmission member and the second transmission member is provided with an arc-shaped block configured to be clamped into the arc-shaped groove, the arc-shaped block is in clearance fit with the arc-shaped groove.

14. The wrench of claim 6, wherein the reversing assembly further comprises a toggle member movably disposed on the wrench body and connected to the driving portion, and at least a portion of the toggle member extends outside the wrench body.

15. The wrench of claim 1, wherein the first pawl assembly further comprises a fifth pawl being engageable with the tooth portion, and when one of the first pawl, the second pawl, and the fifth pawl is engaged with the tooth portion, other two of the first pawl, the second pawl, and the fifth pawl are in the state of incomplete engagement with the tooth portion.

16. The wrench of claim 1, wherein the driving member comprises a driving shaft or a driving ring.

17. The wrench of claim 10, wherein the reversing assembly further comprises a toggle member movably disposed on the wrench body and connected to the driving portion, and at least a portion of the toggle member extends outside the wrench body.
